(19) United States
(12) Patent Application Publication
(10) Pub. No.: US 2009/0064912 A1
(43) Pub. Date: Mar. 12, 2009

(54) EMBROIDERY SEWING MACHINE AND EMBROIDERY-START-POSITION SETTING METHOD

(75) Inventor: Hitoshi Koyake, Gifu-shi (JP)

Correspondence Address: ROSSI, KIMMS & McDOWELL LLP., 20609 Gordon Park Square, Suite 150, Ashburn, VA, 20147, US

(73) Assignee: TOKAI KOGYO MISHIN KABUSHIKI KAISHA, Kasugai-shi, Aichi (JP)

(21) Appl. No.: 11/913,383

(22) PCT Filed: May 2, 2006
(86) PCT No.: PCT/JP2006/309180

§ 371 Date: Nov. 1, 2007

(30) Foreign Application Priority Data
May 2, 2005 (JP) 2005-134370

(51) Int. Cl. D05B 21/00; D05C 9/04; G06F 7/60; D05C 5/02

(52) U.S. Cl. 112/102.5; 112/103; 700/137; 700/138

(57) ABSTRACT

Trace process (i.e. process for moving an embroidery frame from a desired start position on the basis of outline data of an embroidery pattern) is performed. It is detected, during the movement, whether the moving embroidery frame has reached a predetermined movement limit position. When detected, a protrusion amount, from the embroidery frame, of a remaining outline portion is calculated on the basis of a current position of the outline data and the remaining portion. On the basis of the calculated protrusion amount, the start position is reset by being positionally displaced so as to avoid occurrence of the protrusion. In this way, setting a start position such that the embroidery pattern does not protrude beyond a movable range of the embroidery frame can be performed in a short time.

This application is a U.S. National Phase Application of PCT International Application PCT/JP2006/309180 filed on May 2, 2006.

### TECHNICAL FIELD

The present invention relates generally to an embroidery sewing machine provided with a drive mechanism for moving an embroidery frame, having a sewing workpiece held thereon, in accordance with embroidery sewing data corresponding to a desired embroidery pattern, and more particularly relates to an apparatus and method for setting an embroidery start position such that an embroidery pattern to be sewn does not protrude beyond a movable range of the embroidery frame.

### BACKGROUND ART

There have been known methods for ascertaining, prior to embroidering of a given embroidery pattern, whether or not the embroidery pattern will properly fit within a sewable range (i.e., movable range of an embroidery frame). According to one example of the known methods, the embroidery frame is actually moved so as to trace the outline of the embroidery pattern, to thereby visually ascertain whether or not the embroidery pattern fits within a sewable range. Once the tracing is started by moving the embroidery frame through manual frame-moving operation to set a start position, on an embroidering fabric, of the embroidery pattern after entry of data of the embroidery pattern to be embroidered, the embroidery frame moves so that a position corresponding to a needle bar moves relatively on the basis of contour line data of the pattern; thus, whether or not the embroidery pattern will properly fit within the sewable range can be judged through a visual check. In this case, the pattern may extend or protrude beyond the sewable range depending on the initially-set start position; in this situation, the tracing movement of the embroidery frame stops once the embroidery frame reaches a limit of the sewable range, i.e. a limit of a movable range of a frame drive mechanism. After that, a human operator appropriately position ally displaces the start position through manual frame-moving operation and again gives a trace instruction, after which the human operator repeats these operation until the embroidery pattern fits within the sewable range.

With the aforementioned conventional trace technique, however, when it has been found, through the tracing, that the pattern does not fit within the sewable range, there is no other choice but to change the start position by trial and error. Consequently, the operation of changing the start position and then carrying out the tracing has to be repeated again and again, which would take a lot of time and labor to set an appropriate start position.

With an invention disclosed in Japanese Patent No, 3354429, comparison operations are performed to compare an embroidering range of an embroidery pattern and a sewable range of the embroidery frame, to thereby automatically determine whether the embroidery pattern will fit within the sewable range. However, this approach requires data of the sewable range of the embroidery frame to be entered in advance and thus tends to be cumbersome.

### DISCLOSURE OF THE INVENTION

In view of the foregoing, it is an object of the present invention to provide an embroidery sewing machine and embroidery-start-position setting method which allow an embroidery start position to be set, with ease and in a short time, such that an embroidery pattern to be sewn does not protrude beyond a movable range of an embroidery frame.

According to the present invention, there is provided an embroidery sewing machine including a drive mechanism for moving an embroidery frame, having a sewing workpiece held thereon, in accordance with embroidery sewing data corresponding to a desired embroidery pattern, which comprises: a trace control section for driving the drive mechanism, on the basis of outline data including at least extreme values of a given embroidery pattern, to thereby move the embroidery frame from a desired start position in accordance with the outline data; a detection section for detecting that the moving embroidery frame has reached a predetermined movement limit position; a protrusion amount calculation section for, once it is detected by the detection section, during movement of the embroidery frame by the trace control section, that the moving embroidery frame has reached the predetermined movement limit position, calculating a protrusion amount, from the embroidery frame, of a remaining outline portion on the basis of a current position of the outline data and an extreme value of the remaining portion; and a start position setting section for, on the basis of the protrusion amount calculated by the protrusion amount calculation section, resetting the start position by positionally displacing the start position so as to avoid occurrence of the protrusion.

The trace control section actually moves the embroidery frame in accordance with the outline data using the conventionally-known trace technique. As with the conventionally-known trace technique, whether or not the embroidery pattern fits within the embroidery frame can be judged through a visual check, by the control section moving, prior to embroidery of the embroidery pattern onto an embroidering fabric, the embroidery frame, having the fabric held thereon, along the outline of the embroidery pattern (i.e., tracing the outline). According to the aspect of the invention, once it is detected, during the movement of the embroidery frame, that the moving embroidery frame has reached a predetermined movement limit position, a protrusion amount, from the embroidery frame, of a remaining outline portion is calculated on the basis of a current position of the outline data and the remaining portion. Then, on the basis of the calculated protrusion amount, the start position is reset by being positionally displaced so as to avoid occurrence of the protrusion. Unlike the conventional trace technique, the present invention need not change the start position by trial and error and thus can promptly perform setting of a proper embroidery start position. Further, because it is not necessary to enter in advance data of the sewable range of the embroidery range, the present invention can minimize the necessary time and effort.

### BRIEF DESCRIPTION OF DRAWINGS

FIG. 1 is a view showing an outer appearance of an embroidery sewing machine in accordance with an embodiment of the present invention;

FIG. 2 is a plan view showing parts of an embroidery frame and table in the embodiment of FIG. 1;

FIG. 3 is a side view showing an example where limit switches are used as movement limit position detection means related to an X-axis or Y-axis drive mechanism of the embroidery frame;

FIG. 4 is a block diagram showing an example of a hardware setup of a control system pertaining to the movement limit position detection means of the embroidery frame;

FIG. 5 is a block diagram showing another example of the hardware setup of the control system pertaining to the movement limit position detection means of the embroidery frame;

FIG. 6 is a flow chart schematically showing an example of a program of a trace process performed by a CPU shown in FIG. 4 or FIG. 5;

FIG. 7A is a diagram showing an example of an embroidery pattern;

FIG. 7B is a diagram showing an example of outline data of the embroidery pattern;

FIG. 8 is a diagram showing an example way to obtain the outline data of the embroidery pattern;

FIG. 9A is a diagram showing an example where the embroidery frame is set at an arbitrary or desired start position S1 (and where, with such a start position S1, an embroidery pattern protrudes beyond a movable range of the embroidery frame with respect to the X-axis direction);

FIG. 9B is a diagram showing a state where a current position Sx of the moving embroidery frame has reached the limit position, in the X-axis direction, of the movable range;

FIG. 9C is a diagram showing a state where the embroidery frame has been reset at a corrected start position S2;

FIG. 10A is a diagram showing another example where the embroidery frame is set at a desired start position S1 (and where, with such a start position S1, an embroidery pattern protrudes beyond the movable range of the embroidery frame with respect to the Y-axis direction);

FIG. 10B is a diagram showing a state where a current position Sy of the moving embroidery frame has reached the limit position, in the Y-axis direction, of the movable range;

FIG. 10C is a diagram showing a state where the embroidery frame has been reset at a corrected start position S3; and

FIG. 11 is a diagram showing still another example where the embroidery frame is set at a desired start position S1 (and where, with such a start position S1, an embroidery pattern protrudes beyond the movable range of the embroidery frame with respect to both of the X-axis and Y-axis directions.

### BEST MODE FOR CARRYING OUT THE INVENTION

Embodiments of the present invention will hereinafter be described with reference to the accompanying drawings.

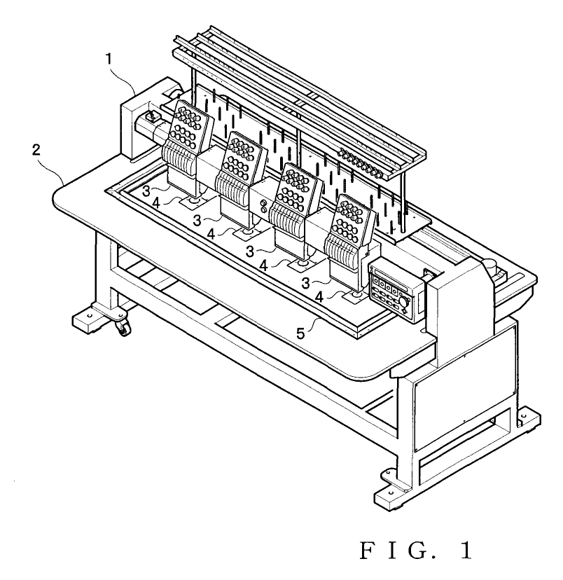

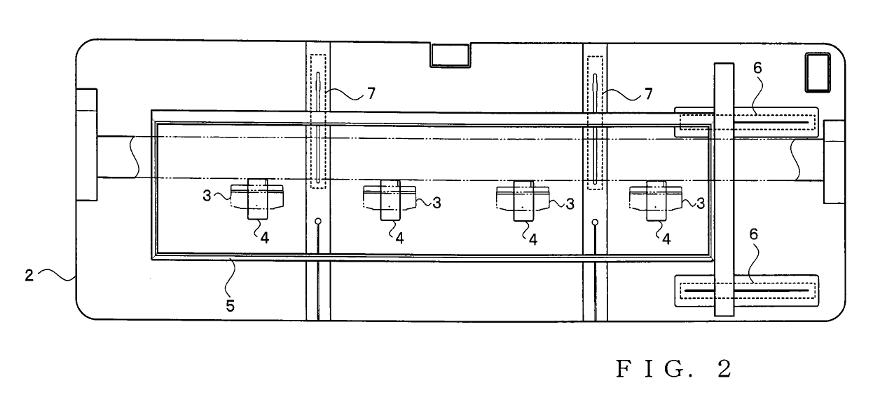

FIG. 1 is a view showing an outer appearance of an embroidery sewing machine in accordance with an embodiment of the present invention; the outer appearance itself is similar to that of the conventionally-known embroidery sewing machines. A plurality of (four in the illustrated example) machine heads 3 are disposed on a machine frame 1 at equal intervals along a left-right horizontal direction of the sewing machine, and a needle plate 4 is disposed immediately beneath each of the machine heads 3 and at generally the same height as the table 2. As shown in a plan view of FIG. 2, an embroidery frame 5 for holding thereon an embroidering workpiece in a stretched-taut state is provided on the table 2 in such a manner that it is movable in X-axis and Y-axis directions. The embroidery frame 5 is driven two-dimensionally in the X-axis and Y-axis directions via an X-axis drive mechanism 6 and Y-axis drive mechanism 7 disposed beneath the table 2.

Specific constructions of the X-axis drive mechanism 6 and Y-axis drive mechanism 7 are the same as the conventional counterparts and thus will not be particularly shown and described here. In the instant embodiment, detection means for detecting that the moving embroidery frame 5 has reached a predetermined movement limit position is provided in relation to the drive mechanisms 6 and 7. FIG. 3 is a side view showing an example of the detection means. X-axis movement section 6a of the X-axis drive mechanism 6 is mounted on one side of the embroidery frame 5. The embroidery frame 5 is movable in the X-axis direction as the X-axis movement section 6a moves, but freely slidable in the Y-axis direction. Dog 8 is mounted on the X-axis movement section 6a, and limit switches 9 and 10 are provided in correspondence with predetermined left and right limit positions in an X-axis direction movement range. Thus, once the X-axis movement section 6a, moving in a leftward direction of FIG. 3, reaches the left movement limit position, the dog 8 activates the left limit switch 9, so that it is detected that the embroidery frame 5 has reached the predetermined left movement limit position. Similarly, once the X-axis movement section 6a, moving in a rightward direction of FIG. 3, reaches the right movement limit position, the dog 8 activates the right limit switch 10, so that it is detected that the embroidery frame 5 has reached the predetermined right movement limit position. The limit switches 9 and 10 may be of either a contact type or a non-contact type. Although the X-axis drive mechanism 6 is shown in FIG. 2 as comprising two parallel movement mechanisms, the limit switches 9 and 10 only have to be provided on one of the two movement mechanisms. Detection means in the Y-axis drive mechanism 7 may be constructed in a similar manner to the detection means in the aforementioned X-axis drive mechanism. Such detection means are not limited to the aforementioned limit-switch (or proximity-switch) type, and may be constructed so as to detect, on the basis of outputs of rotary encoders 13 and 14 (FIG. 5) for detecting rotation of respective rotation motors 11 and 12 (FIG. 5) of the drive mechanisms 6 and 7, that current X-axis and Y-axis positions have reached any of the predetermined limit movement positions.

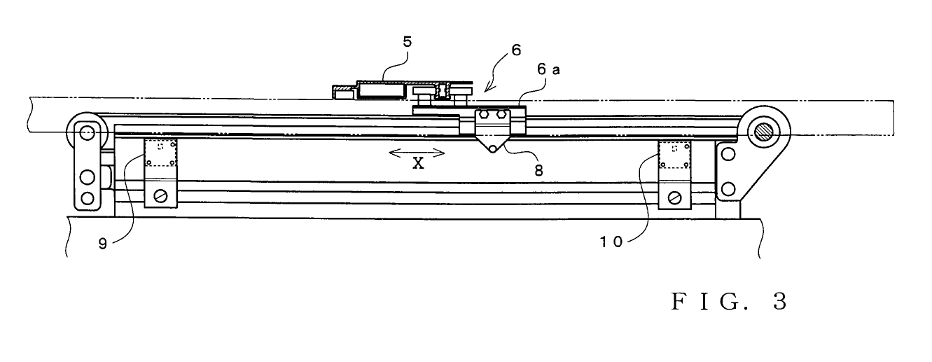

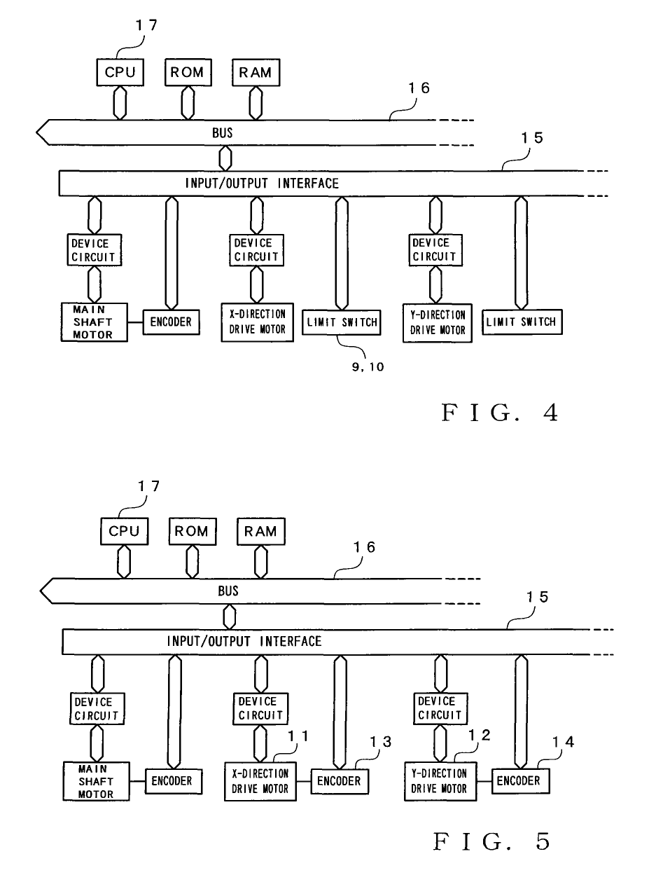

FIGS. 4 and 5 are block diagrams showing an example of a hardware setup of a control system pertaining to the movement limit position detection means of the embroidery frame 5 in the embroidery sewing machine according to the instant embodiment. More specifically, FIG. 4 shows an example where the limit switches 9 and 10 are used as the detection means. In this case, respective output signals of the limit switches 9 and 10 are given, via an input/output interface 15 and bus 16, to a CPU 17, where they are used for a protrusion amount calculation process that will be later described. FIG. 5 shows another example where the outputs of the rotary encoders 13 and 14 for detecting the rotation of the respective rotation motors 11 and 12 of the X- and Y-axis drive mechanisms 6 and 7 are used for the limit position detection purpose. In this case, the respective output signals of the rotary encoders 13 and 14 are given, via the input/output interface 15 and bus 16, to the CPU 17, where they are used for calculation of current X- and Y-axis positions of the embroidery frame. Further, the CPU 17 determines whether the current X- and Y-axis positions of the embroidery frame have reached any of the predetermined movement limit positions, on the basis of which the protrusion amount calculation process is performed. That any of the predetermined movement limit positions has been reached can be detected on the basis of the encoder outputs, because, once the embroidery frame 5 reaches the X-axis or Y-axis, mechanical movement limit position, no position detection is output any longer from the rotary encoder 13 or 14 although a drive instruction has been given. In a case where the drive motors 11 and 12 are closed-loop controlled, it would be more advantageous to employ the construction of FIG. 5 because the position-detecting rotary encoders 13 and 14 are normally provided already. In a case where the drive motors 11 and 12 are open-loop controlled, on the other hand, it would be more economical to employ the construction of FIG. 4 because no particular position-detecting rotary encoder is provided.

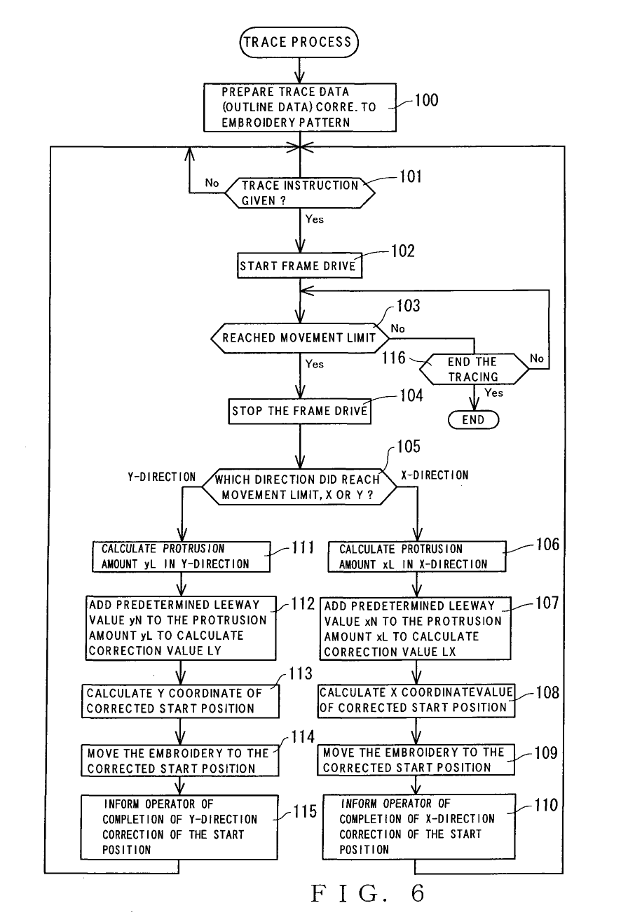

FIG. 6 is a flow chart schematically showing an example of a program of a trace process performed by the CPU 17 of the embroidery sewing machine.

First, an embroidery data set of an embroidery pattern to be embroidered is selected, and trace data of the selected embroidery pattern are prepared (step 100). The “trace data” are outline data of the embroidery pattern which include at least extreme values of the given embroidery pattern, and trace data similar to those known in the conventional trace process may be used here. The “extreme values” are extreme values (maximum or minimum values) of the embroidery pattern pertaining to components, in the individual movement directions, of the embroidery frame. Here, the extreme values are, for example, minimum and maximum values, in the X-axis and Y-axis directions, of the embroidery pattern. The “outline data”, which only have to include at least the extreme values, may be either exact outline data obtained by accurately tracing the outline of the embroidery pattern, or rough outline data obtained by roughly tracing the outline of the embroidery pattern so as to include the individual extreme values.

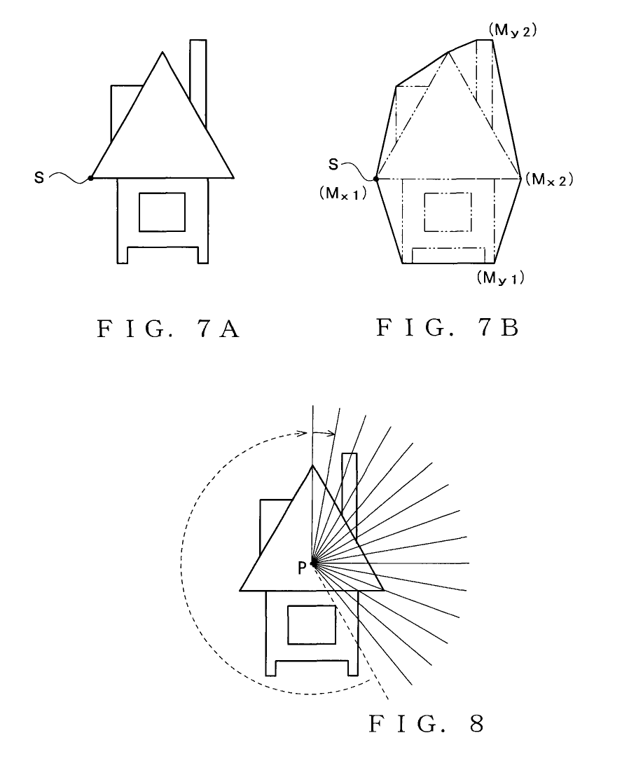

FIG. 7A shows an example of an embroidery pattern, and FIG. 8 shows an example way to obtain outline data of such an embroidery pattern. In FIG. 7A, S represents a sewing start point of the embroidery pattern. Outline data of the embroidery pattern can be obtained by: drawing, outwardly from a given point P within the embroidery pattern, a straight line every predetermined angle to thereby determine intersecting points between the pattern (stitch data) and the straight lines; determining coordinates of the farthest intersecting point, from the point P, of the determined intersecting points with the stitch data for each of the straight lines; and interconnecting the coordinates of the farthest intersecting points. FIG. 7B shows an example of the outline data of the embroidery pattern obtained in the aforementioned manner. Such tracing outline data may be calculated by arithmetic operations at step 100, or may be pre-created outline data stored together with the embroidery pattern data (stitch data) and read out at step 100. In FIG. 7B, there are shown, just for reference, two extreme values Mₓ₁ and Mₓ₂ in the X-axis direction and two extreme values M_{y1} and M_{y2} in the Y-axis direction. Even with the outline data interconnecting only these four extreme, it is possible to accomplish the purpose of determining whether the embroidery pattern fits within the movable range of the embroidery frame.

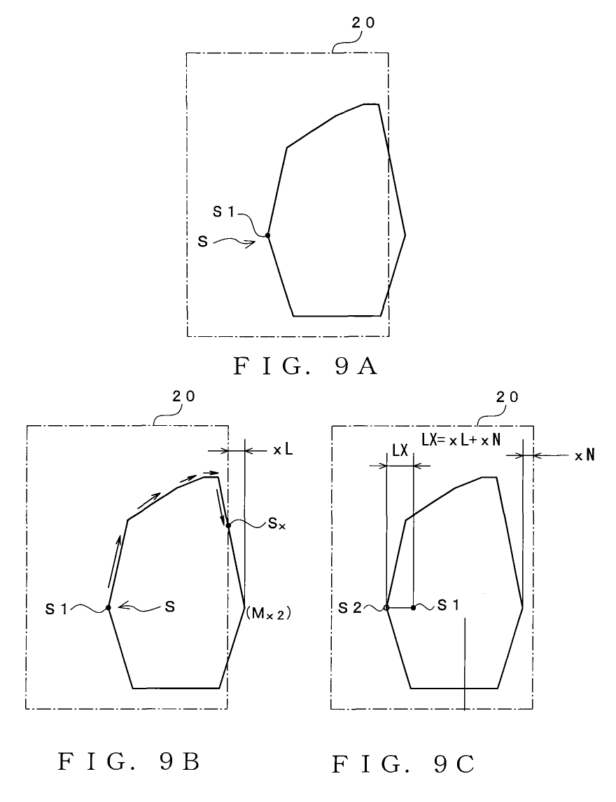

At step 101, a determination is made as to whether a predetermined trace instruction has been given. For example, when the human operator has turned on a predetermined trace instruction switch, it is determined that the predetermined trace instruction has been given. Note that, before giving such a trace instruction, the human operator sets the embroidery frame 5 at a desired start position by appropriately moving the embroidery frame 5. FIG. 9A shows an example where the embroidery frame 5 is set at a desired start position S1 and where, with such a start position S1, an embroidery pattern extends or protrudes beyond the movable range (namely, sewable range) 20 of the embroidery frame 5 with respect to the X-axis direction. The thus-set start position S1 of the embroidery frame 5 becomes a sewing start point S of the embroidery pattern. Here, it is not necessary to known specifically in advance what kind of range the movable range 20 of the embroidery frame 5 is like, and thus, it is not necessary to evaluate in advance the movable range 20 through arithmetic operations or the like. Likewise, coordinates and the like of the start position S1 of the embroidery frame 5 need not be known in advance as specific numerical values, and the human operator may set a suitable position as the start position S1 by merely appropriately moving the embroidery frame 5. In FIG. 9A, a contour line corresponding to the outline data is also shown, just as a reference, with the sewing start point S of the embroidery pattern coinciding with the start position S1 of the embroidery frame 5. Although the contour line is shown as running out or protruding beyond the movable range 20 with respect to the X-axis direction in the illustrated example, relationship between the outline data of the embroidery pattern and the movable range 20 of the embroidery frame 5, i.e. whether the contour line is protruding beyond the movable range 20, is not specifically known, at this stage, to the human operator and to a control device as well.

Once a trace instruction has been given, movement of the embroidery frame 5 is started in accordance with the outline data (step 102). As indicated by arrows in FIG. 9B, the movement of the embroidery frame 5 is started at the start point S and carried out in such a manner as to sequentially trace the contour line represented by the outline data.

At step 103, a determination is made as to whether the moving embroidery frame 5 has reached any of the predetermined movement limit positions. This determination is made by the CPU 17 checking the outputs of the limit switches 9 and 10 or output states of the position-detecting encoders 13 and 14 as shown in FIG. 4 or 5. When a current position Sx of the moving embroidery frame 5 has reached the X-axis-direction movement limit position of the movable range 20, the arrival at the X-axis-direction movement limit is detected (YES determination at step 103). The movement of the embroidery frame 5 is terminated in response to the X-axis-direction movement limit detection (step 104), and then it is determined in which of the X-axis and Y-axis directions the current position Sx has reached the limit position (step 106). In the illustrated example of FIG. 9B, the arrival at the X-axis-direction right movement limit position detection is detected, and the process goes to step 106.

At step 106, a protrusion amount xL of a remaining outline portion, protruding beyond the embroidery frame, is calculated on the basis of the current position Sx and extreme value Mₓ₂ of the remaining outline portion represented by the outline data (e.g., xL=Mₓ₂−Sx). Then, a predetermined leeway amount xN is added to the calculated protrusion amount xL of to calculate a correction value LX (step 107), and then the X coordinate value of the initially-set start position S1 is corrected by the correction value LX so as to calculate an X coordinate value of a corrected start position S2 (step 108). In this way, the X coordinate value of the start position S2, corrected so as to avoid the protrusion in the X-axis direction, is calculated, and the embroidery frame 5 is automatically moved to the corrected start position S2 (step 109). Upon completion of the movement of the embroidery frame 5 to the corrected start position S2, the completion of the movement is informed to the human operator by means of a suitable informing means (such as an audibly- or visibly-informing means like a buzzer or illumination)(step 110). In this manner, the start position of the embroidery frame 5 is positionally displaced from the arbitrarily-set or desired position S1 by the correction value LX and reset at the corrected start position S2. Note that, at step 109, the human operator may be instructed, via a visual display, sound or the like, to manually move the embroidery frame 5 to the corrected start position S2, instead of the embroidery frame 5 being automatically moved to the corrected start position S2.

After the embroidery frame 5 has been reset at the corrected start position S2, a trace instruction is given one more time for a confirmation purpose (step 101). Thus, this time, the movement of the embroidery frame 5 is started at the corrected start position S2 in accordance with the outline data, (step 102). If there is no pattern protrusion in the Y-axis direction as shown in FIG. 9C, it is not determined, at step 103, that the embroidery frame 5 has reached any of the movement limit positions. Thus, the movement (tracing), based on the outline data, of the embroidery frame 5 is brought to an end with the NO determination at step S13 maintained. At step 116, it is determined that the tracing has been completed, in response to detection that the movement, based on the outline data, of the embroidery frame 5 has returned to the start position S2. Thus, the trace process is brought to an end. In this manner, it is confirmed that, with the start position S2 having been set till the end of the trace process, there occurs pattern protrusion in neither the X-axis direction nor in the Y-axis direction as shown in FIG. 9C.

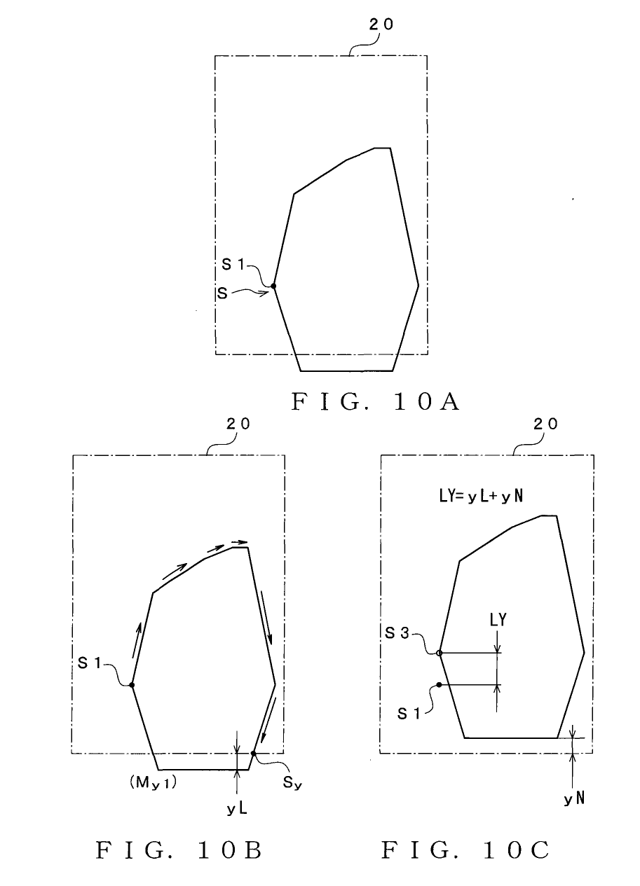

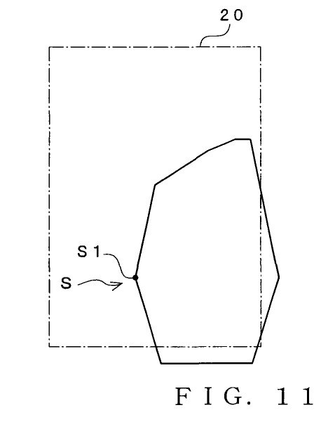

The following lines describe an example where, with the initially-set start position S1 of the embroidery frame 5, the embroidery pattern protrudes beyond the movable range (i.e., sewable range) 20 of the embroidery frame 5 with respect to the Y-axis direction as shown in FIG. 10A. In this case, a trace instruction is given (step 101), so that the movement of the embroidery frame 5 is started in accordance with the outline data (step 102). When a current position Sy of the moving embroidery frame 5 has reached the Y-axis-direction movement limit position of the movable range 20, the arrival at the Y-axis-direction movement limit position is detected (YES determination at step 103 of FIG. 6). The movement of the embroidery frame 5 is terminated in response to the Y-axis-direction movement limit detection (step 104), then it is determined that the direction in which the current position Sx has reached the limit position is the Y-axis direction (step 106), and the process goes to step 111. At steps 111-115, the aforementioned operations of steps 106-110 are performed for the Y axis. Namely, at step 111, a protrusion amount yL of a remaining outline portion, protruding beyond the embroidery frame, is calculated on the basis of the current position Sy and extreme value M_{y1} of the remaining outline portion represented by the outline data (e.g., yL=M_{y1}−Sy). Then, a predetermined leeway amount yN is added to the protrusion amount yL of to calculate a correction value LY (step 112), and then the Y coordinate value of the initially-set start position S1 is corrected by the correction value LY so as to calculate a Y coordinate value of a corrected start position S3 (step 113). Then, the embroidery frame 5 is automatically moved to the corrected start position S3 (step 114). Upon completion of the movement of the embroidery frame 5 to the corrected start position S3, the completion of the movement is informed to the human operator (step 115). In this manner, the start position of the embroidery frame 5 is positionally displaced from the arbitrarily-set or desired position S1 by the correction value LY and reset at the corrected start position S3. After the embroidery frame 5 has been reset at the corrected start position S3, a trace instruction is given one more time for a confirmation purpose (step 101). Thus, this time, the movement of the embroidery frame 5 is started at the corrected start position S3 in accordance with the outline data (step 102). If there is no pattern protrusion in the X-axis direction as shown in FIG. 10C, the movement (tracing), based on the outline data, of the embroidery frame 5 is brought to an end with the NO determination at step S13 maintained. In this manner, it is confirmed that, with the start position S3 having been set till the end of the trace process, there occurs pattern protrusion in neither the X-axis direction nor in the Y-axis direction as shown in FIG. 10C.

Next, a description will be given about an example where, with the initially-set start position S1 of the embroidery frame 5, the embroidery pattern protrudes beyond the movable range (i.e., sewable range) 20 of the embroidery frame 5 with respect to both of the X-axis and Y-axis directions as shown in FIG. 11. In this case, a trace instruction is given (step 101), so that the movement of the embroidery frame 5 is started in accordance with the outline data (step 102). When the current position of the moving embroidery frame 5 has reached the limited position, in one of the X-axis and Y-axis-directions, of the movable range 20, a corrected start position is set, through the operations at steps 106-110 or 111-115, so as to eliminate the protrusion in the one, i.e. X-axis or Y-axis, direction. Then, the trace instruction is given again (step 101), so that the movement of the embroidery frame 5 is started in accordance with the outline data (step 102). When the current position of the moving embroidery frame 5 has reached the limited position, in the other of the X-axis and Y-axis-directions, of the movable range 20, a corrected start position is set, through the operations at steps 106-110 or 111-115, so as to eliminate the protrusion in the other, i.e. Y-axis or X-axis, direction. Finally, the trace instruction is given again just for a confirmation purpose (step 101), so that the movement of the embroidery frame 5 is started in accordance with the outline data (step 102). This time, the tracing can be brought to an end without the outline data protruding in any one of the X-axis and Y-axis directions. Because any protrusion in both of the X-axis and Y-axis directions has already been eliminated in accordance with the second trace instruction, the third trace instruction is merely for a confirmation purpose and thus may be dispensed with.

As set forth above, in the case where, with the initial arbitrarily-set or desired start position S1, the outline data protrude beyond the movable range 20 in the X- or Y-axis direction, the trace instruction is given twice, so that a start position, eliminating a possibility of protrusion, can be set reliably.

Note that the leeway values xN and yN to be used for determining the aforementioned corrected start position may be set by the human operator on an operation panel in accordance with a form of the embroidery frame employed.

The present invention is also applicable to cases where is employed an embroidery frame of a cylindrical shape or curved-surface shape, without being limited to the planar-shaped embroidery frame 5 driven two-dimensionally along the X-axis and Y-axis. Further, the present invention is also applicable to single-head embroidery sewing machines, without being limited to multi-head embroidery sewing machines. Furthermore, the present invention is also applicable to embroidery sewing machines that perform embroidery, cutting, etc. of sequins and/or strings, without being limited to embroidery of threads; these machines are generically called “embroidery sewing machines”.

1. An embroidery sewing machine including a drive mechanism for moving an embroidery frame, having a sewing workpiece held thereon, in accordance with embroidery sewing data corresponding to a desired embroidery pattern, said embroidery sewing machine comprising:
trace control section that drives the drive mechanism, on the basis of outline data including at least extreme values of a given embroidery pattern, to thereby move the embroidery frame from a desired start position in accordance with the outline data;
detection section that detects that the moving embroidery frame has reached a predetermined movement limit position;
protrusion amount calculation section that, once it is detected by said detection section, during movement of the embroidery frame by said trace control section, that the moving embroidery frame has reached the predetermined movement limit position, calculates a protrusion amount, from the embroidery frame, of a remaining outline portion on the basis of a current position of the outline data and an extreme value of the remaining portion; and
start position setting section that, on the basis of the protrusion amount calculated by said protrusion amount calculation section, resetting the start position by positionally displacing the start position so as to avoid occurrence of the protrusion.

2. An embroidery sewing machine as claimed in claim 1 wherein calculation of the protrusion amount by said protrusion amount calculation section and resetting of the start position by said start position setting section is performed per movement axis component.

3. An embroidery sewing machine as claimed in claim 1 wherein said start position setting section automatically moves the embroidery frame to the reset start position.

4. An embroidery sewing machine as claimed in claim 1 wherein said start position setting section audibly or visibly informs the reset start position.

5. An embroidery-start-position setting method for an embroidery sewing machine, said embroider-start-position setting method comprising:
a step of, on the basis of outline data including at least extreme values of a given embroidery pattern, moving an embroidery frame from a desired start position in accordance with the embroidery sewing data;
a step of detecting whether the moving embroidery frame has reached a predetermined movement limit position;
a step of, once it is detected by said step of detecting that the embroidery frame, moving in accordance with the outline data, has reached the predetermined movement limit position, calculating a protrusion amount, from the embroidery frame, of a remaining outline portion on the basis of a current position of the outline data and an extreme value of the remaining portion; and
a step of, on the basis of the calculated protrusion amount, resetting the start position by positionally displacing the start position so as to avoid occurrence of the protrusion.

6. A computer-readable storage medium storing a program for causing a computer to perform an embroidery-start-position setting procedure for an embroidery sewing machine, said embroidery-start-position setting procedure comprising:
a step of, on the basis of outline data including at least extreme values of a given embroidery pattern, moving an embroidery frame from a desired start position in accordance with the embroidery sewing data;
a step of detecting whether the moving embroidery frame has reached a predetermined movement limit position;
a step of, once it is detected by said step of detecting that the embroidery frame, moving in accordance with the outline data, has reached the predetermined movement limit position, calculating a protrusion amount, from the embroidery frame, of a remaining outline portion on the basis of a current position of the outline data and an extreme value of the remaining portion; and
a step of, on the basis of the calculated protrusion amount, resetting the start position by positionally displacing the start position so as to avoid occurrence of the protrusion.

7. A program as claimed in claim 6 which further comprises a step of creating the outline data, including the at least extreme values of the embroidery pattern, on the basis of given embroidery pattern data.
